(19) United States
(12) Patent Application Publication
(10) Pub. No.: US 2002/0194007 A1
(43) Pub. Date: Dec. 19, 2002

(54) Electronic transaction service system

(76) Inventor: Dennis G. Earnshaw, Tualatin, OR (US)

Correspondence Address: IPSOLON LLP, 805 SW Broadway #2740, Portland, OR, 97205, US

(21) Appl. No.: 09/849,513

(22) Filed: May 5, 2001

(51) Int. Cl. G06F 17/60

(52) U.S. Cl. 705/1

(57) ABSTRACT

An electronic business transaction service method includes creating on an originating computer an electronic business transaction document that is compatible with a business management software program capable of automatically populating and extracting information from electronic business transaction document. The electronic business transaction document is directed to at least one recipient party to a business transaction in a computer communication format and to at least one other recipient party in to the business transaction a non-computer communication format. The electronic business transaction document is transmitted over the computer network to a network-connected transaction service server computer, which sends the electronic business transaction document to the recipient parties in their computer and non-computer communication formats. The non-computer communication format may include telephonic facsimile.

### FIELD OF THE INVENTION

This invention relates to business-to-business electronic commerce and, in particular, to conducting such electronic commerce in which transaction documents may be received in computer and non-computer communication formats.

### BACKGROUND AND SUMMARY OF THE INVENTION

Business-to-business electronic commerce has long promised significant improvements in the speed, accuracy, and efficiency with which transactions between businesses can be conducted. In industries such as construction, for example, a project may entail tens of thousands transactions relating to acquisition of building materials, sub-contractor services, project scope, etc. In the conventional manual manner of conducting such transactions, suppliers and contractors each require staff who interpret and manually enter transaction information that is received as a printed transaction documents via mail or telephonic facsimile. Business-to-business electronic commerce has offered the promise of transmitting such transaction information electronically, thereby decreasing the cost and errors that can arise in conventional manual processing of transaction documents.

One type of business-to-business electronic commerce is called electronic data interchange (EDI). Two well-known standards for EDI are the ANSI X 12 standard, promulgated by the American National Standards Institute, and UN/EDIFACT, an international standard used especially widely in Western Europe. A limitation on the implementation of business-to-business electronic commerce has been the requirement that both parties to a transaction adopt a common business-to-business electronic commerce system or protocol. In practice, that means that every supplier, contractor, vendor, etc. in the industry must adopt the same standard. The expense, time, and cooperation required to implement for such an industry-wide standard can be significant.

The present invention includes an electronic business transaction service method for conducting a business transaction at least in part over a computer network. The method includes creating on an originating computer an electronic business transaction document that is compatible with a business management software program capable of automatically populating and extracting information from electronic business transaction document. In one implementation, the electronic business transaction document is directed to at least one recipient party to a business transaction in a computer communication format and to at least one other recipient party in to the business transaction a non-computer communication format. The electronic business transaction document is transmitted over the computer network to a network-connected transaction service server computer, which sends the electronic business transaction document to the recipient parties in their computer and non-computer communication formats. The non-computer communication format includes, for example, telephonic facsimile. In another implementation, the electronic business transaction document could be directed to recipient parties only in one or more computer communication formats.

The electronic business transaction service method of this invention allows the operator of an originating computer with business management software to create and transmit an electronic business transaction document to effect business-to-business electronic commerce regardless of the communication format used by the intended recipient or recipients. The operation of the transaction service server allows a single electronic business transaction document to be transmitted to multiple parties using multiple different communication formats. As a result, the operator of the originating computer may create and transmit an electronic business transaction document entirely within the context of the business management software while supporting the communication format preferred by each of the recipient parties.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a block diagram illustrating communication between parties associated with a business project as one operating environment for the present invention.

FIG. 2 is a flow diagram illustrating an originating electronic transaction document transmission service method for conducting business-to-business electronic commerce according to the present invention.

FIG. 3 is a diagram of an exemplary electronic business transaction document.

FIG. 4 is a diagrammatic illustration of an address book data structure with a business transaction document communication format field.

FIG. 5 is a flow diagram illustrating a responding electronic transaction document transmission method for conducting business-to-business electronic commerce according to the present invention.

### DETAILED DESCRIPTION OF PREFERRED EMBODIMENTS

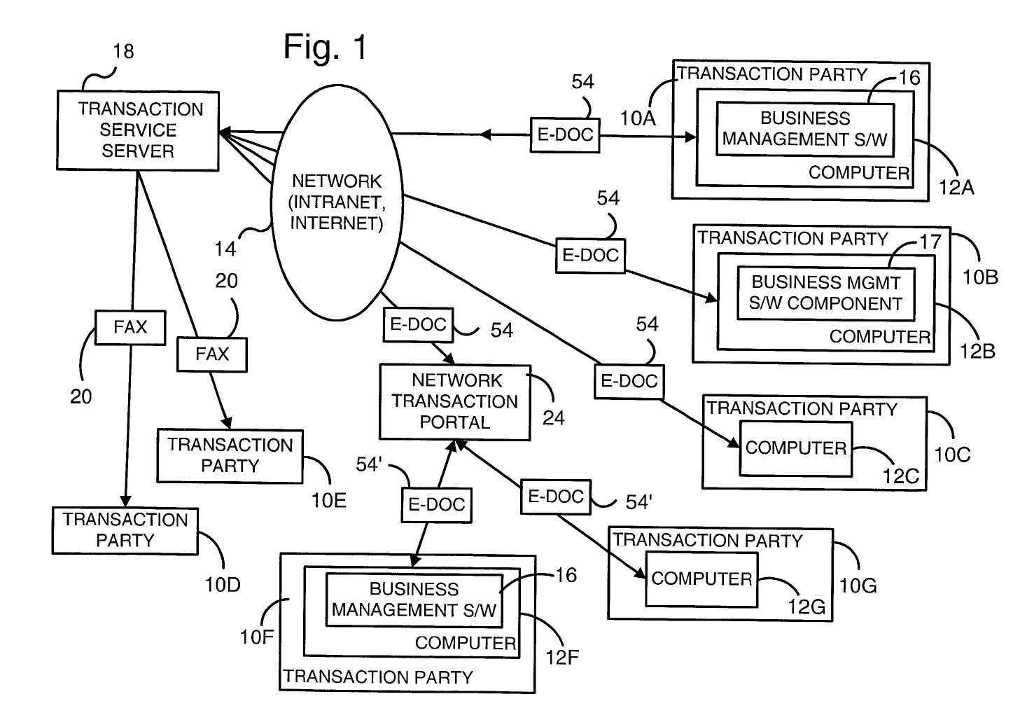

FIG. 1 is a block diagram illustrating communication between actual or potential parties 10, such as contractors, suppliers, vendors, etc., that are or could be associated with a business project. For purposes of illustration, the business project is described as being a construction project, and the contractors, suppliers, vendors, etc. are associated with the construction industry and provide, offer, or request goods or services for the construction project.

Ones of parties 10 have associated with them client computers 12 that communicate with a computer network 14, such as a LAN, WAN, an intranet, or the Internet. Each of computers 12 has, for example, a conventional computer configuration that may include a high speed processing unit (CPU) in conjunction with a memory system (with volatile and/or non-volatile memory), an input device, and an output device, as is known in the art.

One or more of computers 12 (e.g., computer 12A) further includes business management software 16 for managing various aspects of a business project, including communications and transactions with business parties such as contractors, suppliers, vendors, etc., transaction and other project accounting, overall project management, etc. With regard to the exemplary construction industry, for example, business management software 16 is available from Timberline Software Corporation of Beaverton, Oreg., the assignee of the present invention, as well as others. Also, one or more of computers 12 (e.g., computer 12B) may include a business management software component 17 that is a component, subset, or simplified version of business management software 16. Business management software component 17 is compatible with business management software 16, but has reduced functionality. For example, business management software 16 may be capable of automatically populating and extracting information from selected documents, while business management software component 17 is not.

Network 14 carries communication between client computers 12 and a transaction service server 18. Transaction service server 18 includes one or more computers that provide services or information to client computers 12. Transaction service server 18 runs network server software that coordinates communications with client computers 12. For example, information may be transferred between client computers 12 and transaction service server 18 as mark-up language program files (e.g., XML) and can include text, programs, graphics, video, and audio portions, as is known in the art.

In addition to communicating with client computers 12, transaction service server 18 is capable of sending non-computer format communications, such as telephonic facsimile 20 to parties 10 who do not use client computers 12 for communication. In one implementation, transaction service server 18 also communicates with a networked transaction portal 24 (e.g., a business-to-business Web site) that is accessed via the computer network by parties 10 using computers 12. In one implementation, transaction service server 18 communicates with transaction portal 24 as if it were a party or potential party that is or could be associated with the business project. In this implementation, transaction portal 24 functions as a proxy party that is accessed by or delivers information to actual parties or potential parties 10.

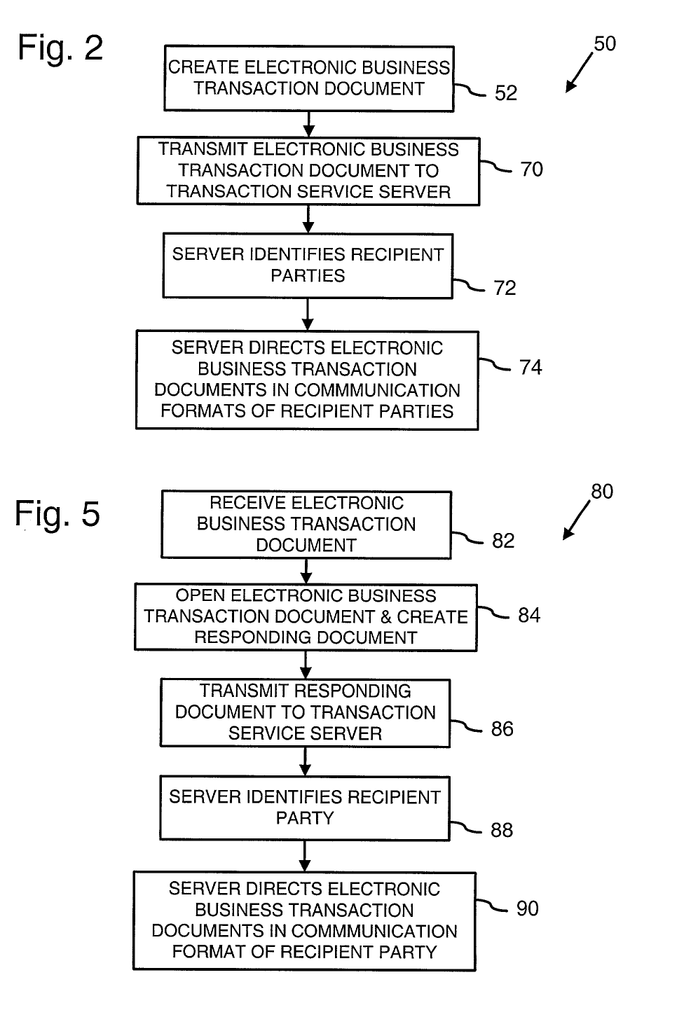

FIG. 2 is a flow diagram illustrating an originating electronic transaction document transmission service method 50 for conducting business-to-business electronic commerce according to the present invention. In one implementation, originating electronic transaction document service method 50 is performed at least in part by software elements that are included in or associated with business management software 16. In electronic transaction document transmission service method 50, electronic transaction documents are transmitted to transaction service server 18, which forwards the electronic transaction documents to parties 10 in preselected communications formats, as described below in greater detail.

Process block 52 indicates that an electronic business transaction document 54 is created on a computer with business management software 16 (e.g., computer 12A), or business management software component 17 (e.g., computer 12B), to effect a business-to-business electronic commerce transaction. For purposes of illustration, the following description refers to electronic business transaction document 54 being created with business management software 16 on computer 12A operated by a party 10A, but is similarly applicable to business management software component 17 on computer 12B.

In one implementation, electronic business transaction document 54 may include one or more of the following:

Request for Quote

Quote

Purchase Order

Subcontract

Accounts Payable Invoice

Accounts Receivable Invoice In other implementations, the electronic business transaction document may additionally or alternatively include one or more of the following:

Bulletin

Change Order

Change Order Log

Change Order Request

Change Order Request Log

Daily Report

Drawing Log

Estimate

Forecast

Owner Manuals Log

Meeting Minute

Contact

Contract

Project Setup Sheet

Punch List

Purchase Order Change Order

Quote Log

Requests For Information

Request For Information Log

Subcontract Change Order

Submittal Log

Work Order

Work Order Log

Transmittal

Field Work Authorizations/Field Change Order

Lease

Tenant Statement

Safety Notice

Pay applications/Draw Request

Project log

Material delivery receipt

Material delivery receipt log

Time cards

Repair order

Daily report log

Proposal

Report

Sent & Received log

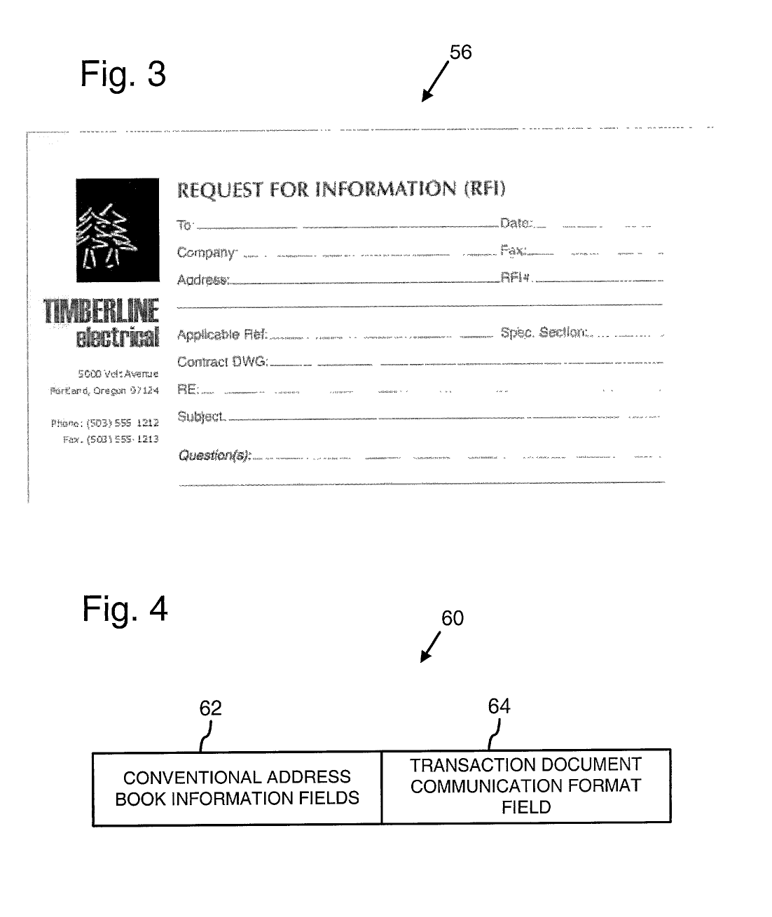

FIG. 3 is a diagram of an exemplary electronic business transaction document 56 in the form of a purchase order relating to a construction project.

Electronic business transaction document 54 includes or has associated with it an indication of the recipient party or parties 10 to whom the document is directed. Business management software 16 with which electronic business transaction document 54 is created includes or has associated with it an electronic address book (not shown) that lists parties 10 with whom party 10A transacts electronic business transactions. The address book may include conventional information about each party 10, such as name, business name, address, telephone number, facsimile number, email address, etc.

In addition, the address book includes for each party 10 an information field indicating the preferred communication format for transmitting electronic business transaction documents 54 to the party. FIG. 4 is a diagrammatic illustration of an address book data structure 60 that includes conventional address book information fields 62 and a business transaction document communication format field 64. As described below in greater detail, business transaction documents are transmitted to parties 10 listed in such an address book according to the communication format indicated at the time the document is sent. In one implementation, the preferred communication format indicated in the address book is used as a prefill when preparing a document, but the communication format can be changed by the operator before the document is sent for each party, regardless of whether the communication format is of a computer or non-computer type. The indication of the party or parties 10 to whom the electronic business transaction document is directed includes for each party information from business transaction document communication format field 64 indicating the preferred communication format.

The various computer and non-computer communication formats represented by business transaction document communication format field 64 correspond to the preferred communication formats for each party 10. Many realms of business, including construction, have great disparities in the degree of automation of the various parties participating in a business project. A common limitation to introducing automated interaction between parties is the burden of maintaining communication with the least automated of the parties. In some instances, even a few parties with little or no automation can undermine many of the efficiencies that automation could otherwise provide other parties.

Process block 70 indicates that electronic business transaction document 54 is transmitted over network 14 to transaction service server 18. The electronic business transaction document may be transmitted in accordance with the HyperText Transfer Protocol (HTTP), File Transfer Protocol (FTP), or in some other network file transfer format, or as a file attached to an e-mail address associated with transaction service server 18.

In one implementation, electronic business transaction document 54 is represented as a markup language computer file (e.g., an EXtensible Markup Language (XML) computer file) and may include other files (e.g., graphics, scripts, etc.) or links to them. Examples of XML computer files for another electronic business transaction document are set forth in Tables 1 and 2. In these implementations, each electronic business transaction document 54 is contained within a message envelope, as designated by the TsEnvelope tag, for example. The message envelope data structure allows each electronic business transaction document 54 to include indications of the source and recipient of electronic business transaction document 54, as well as a message identifier (MessageId), and a documents tag (<Documents>) identifying one or more business transaction document types (e.g., BuyoutDocument or FaxDocument) included in the electronic business transaction document 54, the communication format

In addition, a messageType tag designates the communication format in which the electronic business transaction document 54 is to be transmitted. In Table 1, for example, the messageType tag indicates “iDox,” which indicates an electronic business transaction document 54 to be transmitted in a computer communication format such as the illustrated XML computer file format. In Table 2, for example, the messageType tag indicates “fax,” which indicates an electronic business transaction document 54 to be transmitted in a computer communication format.

TABLE 1
<TsEnvelope xmlns=“x-schema:www.timberline.com\XMLSchemas\
TSEnvelope.Xdr”

thisMessageId=“4E36E11600D749C08A5C7ABAF3644483”
messageDatetime=“25-Aug-2000 14:00”
messageType=“iDox”
status=“request”>

<Message subject=“Electrical Conduit and Wire”>

<Recipients type=“to”>

<Contact name=“Sam Jones”>

<EmailAddress email=“sjones@acme.com”/>
<TSExchangeAccount name=“Sjones@AcmeElectric”/>

</Contact>

</Recipients>
<Sender>

<TSExchangeAccount name=
“GeorgeJ@ABCGeneralContractor”/>

</Sender>

```
  </Message>
  <Documents>
```

<BuyoutDocument formID=“F1” dataID=“d1”> details intentionally
left out

</BuyoutDocument>
</Documents>
</TsEnvelope>

TABLE 2
<TsEnvelope xmlns=“x-schema:www.timberline.com\XMLSchemas\

TSEnvelope.Xdr”

thisMessageId=“1E56E11600D749C08A5C7ABAF3644483”
messageDatetime=“25-Aug-2000 14:00”
messageType=“fax”
status=“request”>

<Message subject=“Lumber for ABC Building”>

<Recipients type=“to”>

<Contact name=“Mary Smith”>

<EmailAddress email=“msmith@SmithLumber.com”/>
<TSExchangeAccount name=
“MarySmith@SmithLumberTown”/>

</Contact>

</Recipients>
<Sender>

<TSExchangeAccount name=
“GeorgeJ @ ABCGeneralContractor”/>

</Sender>

```
  </Message>
  <Documents>
```

<FaxDocument type=“HTML”>

<HTML>

<BODY>details intentionally left out</BODY>

</HTML>

</FaxDocument>

</Documents>
</TsEnvelope>

In one implementation, the preferred communication format for a recipient may be conventional (i.e., paper) mail. As a result, the prefill or default is to generate a paper or “hard” copy of electronic business transaction document 54 for mailing or otherwise sending to the recipient. For example, such a paper or “hard” copy of electronic business transaction document 54 may be generated where electronic business transaction document 54 originates (e.g., at computer 12A or 12B) and mailed or otherwise shipped therefrom. As another example, electronic business transaction document 54 destined for delivery in a hard copy or mailed format may be transmitted over network 14 to transaction service server 18 where a paper or “hard” copy of electronic business transaction document 54 may be generated and mailed or otherwise shipped. In the latter example, the messageType tag would include an indication of a hard copy or mailed communication format.

Process block 72 indicates that transaction service server 18 identifies the parties 10 to whom the electronic business transaction document is directed as “recipient parties.” For example, the recipient parties may be specifically identified by one or more “recipients” tags in the electronic business transaction document, as illustrated in Table 1. In this illustration, one recipient party (i.e., Sam Jones in Table 1) is indicated to receive electronic business transaction document 54 in a computer communication format, and another party (Mary Smith in Table 2) is indicated to receive electronic business transaction document 54 in a non-computer (i.e., telephonic facsimile) communication format.

Electronic business transaction document 54 also includes two identifiers: a form identifier (“formID,” Example 1) that determines how the XML data are to be viewed/presented, and data identifier (“dataID,” Example 1) that uniquely identifies the data in the document. The combination of the dataID and formID completely determine the format of and data in electronic business transaction document 54.

In the illustrated implementation, the form identifier functions to identify the document form, type or template (e.g., a request for information adapted for a particular business entity, as shown in FIG. 3) upon which electronic business transaction document 54 is based. The data identifier functions to identify the data that populates the document form, type or template. The document form, type or template corresponding to the form identifier and the data corresponding to the data identifier are accessible from at least one computer on network 14. It will be appreciated that the computer on network 14 may be computer 10A from which electronic business transaction document 54 is to be transmitted, or may be another computer on network 14.

Process block 74 indicates that transaction service server 18 directs electronic business transaction document 54 in a computer communication format (e.g., an XML file) or a non-computer communication format (e.g., fax 20), to each destination party in the communication format associated with the party. For example, the communication formats are based upon the message type attribute in the TS envelope.

As illustrated in FIG. 1, for example, transaction service server 18 transmits electronic business transaction document 54 in a computer communication format to computers 12B and 12C and network transaction portal 24, and transmits electronic business transaction document 54 in a non-computer communication format to parties 10D and 10E. If electronic business transaction document 54 is being transmitted to a computer without business management software 16 or business management software component 17 (e.g., computer 12C), transaction service server 18 may also transmit a link to or a copy of business management software component 17, for example. Such a link could be transmitted automatically the first time transaction service server 18 transmits to each computer 12.

In one implementation, network transaction portal 24 is accessible by users, such as parties 10F and 10G, in the manner of an Internet Web site, for example. Computers 12F and 12G could include conventional network browser software for accessing network transaction portal 24 and obtaining electronic business transaction documents 54′ therefrom. For example, electronic business transaction document 54 could be a Request for Quote that parties 10F and 10G could obtain and respond to. Electronic business transaction documents 54′ are differentiated by their reference numerals from electronic business transaction documents 54 to indicate that the former may optionally be of a different electronic file format from the latter. For example, electronic business transaction documents 54′ may be of an HTML file format so as to be accessible with network browser much like any conventional “Web site” page. It will be appreciated, however, that electronic business transaction documents 54′ could also have the same file format (e.g., XML) as electronic business transaction documents 54.

Electronic transaction document transmission service method 50 allows the operator of computer 10A with business management software 16 to create and transmit electronic business transaction document 54 to effect business-to-business electronic commerce regardless of the communication format of the intended recipient or recipients. The operation of transaction service server 18 allows the operator of computer 10A to transmit a single electronic business transaction document 54 to multiple parties 10 who can receive electronic business transaction document 54 in multiple different communication formats. As a result, the operator of computer 10A may create and transmit electronic business transaction document 54 entirely within the context of business management software 16 without having to resort to legacy communication formats of other parties.

In one implementation, a business transaction document transmission service fee is charged to the transmitting party (e.g., party 10A) for each electronic business transaction document 54 that is transmitted from transaction service server 18. For example, the fee could be charged for each recipient party 10 to which an electronic business transaction document 54 is transmitted, regardless of the communication format in which the document is transmitted. By combining the efficiencies of business management software 16 with conforming electronic business transaction documents 54 and a fee-based document transmission service that supports multiple recipient communication formats, the overall cost of conducting business electronic commerce can be reduced from traditional arrangements that require an originating party to manually transmit in multiple communication formats.

FIG. 5 is a flow diagram illustrating a responding electronic transaction document transmission method 80 for conducting business-to-business electronic commerce according to the present invention. Some aspects of responding electronic transaction document method 80 may be performed at least in part by software elements that are included in or associated with business management software 16 or business management software component 17.

Process block 82 indicates that an originating electronic transaction document (e.g., document 54) is received at a receiving computer, such as computer 12B with business management software component 17, for example.

Process block 84 indicates that the originating electronic transaction document is opened and a responding electronic business transaction document 54 is created on, for example, the receiving computer (e.g., computer 12B) with business management software component 17. Business management software component 17 differs from business management software 16 in that the former will not include the same range of functionality for communications and transactions with business parties such as contractors, suppliers, vendors, etc., transaction and other project accounting, overall project management, etc. In one implementation, business management software component 17 may perform any number of the following functions:

New—allows the user to select a blank form from which to create a new document.

Save—saves the document in an XML file and creates an entry in the ‘Sent and Received Log’

Print—prints the document.

Cut—moves the current selection to the Windows clipboard.

Copy—copies the selected text to the Windows clipboard.

Paste—copies the contents of the Windows clipboard to the control in focus.

Delete—deletes the document.

Attach—displays a list of electronic transaction documents and system files. One or more electronic objects can be attached to a document.

Undo—reverses an action.

Format Font—allows the user to control the style, size, color, etc. of the current selection.

Format Paragraph—allows the user to determine line spacing, indentation, the use of bullets, etc.

Send—allows the document to be emailed, faxed or printed.

View—allows the user to switch between Page and Screen view

Help—provides user assistance.

Business management software component 17 allows the operator of computer 12B, for example, to perform any of the listed functions with regard to the originating electronic transaction document 54, or with regard to other electronic transaction documents. As a result, the operator of computer 12B may manually process the originating electronic transaction document 54 according to normal business management practices of that business.

Process block 86 indicates that the responding electronic business transaction document that is compatible with business management software 16 is transmitted over network 14 to transaction service server 18.

Process block 88 indicates that transaction service server 18 identifies the party to whom the responding electronic business transaction document is directed (e.g., party 10A).

Process block 90 indicates that transaction service server 18 directs the responding electronic business transaction document to the originating party. Typically, the responding electronic transaction business transaction document would be received and processed automatically by business management software 16 on, for example, computer 10A. In one implementation, business management software 16 retrieves information from the responding electronic transaction business transaction document automatically without manual data manipulation by the computer operator.

Responding electronic transaction document transmission method 80 is described with reference to an electronic transaction document response. For recipient parties that receive the electronic business transaction document in a non-computer communication format (e.g. parties 10D and 10E), responses could be sent directly to the originating party (e.g., party 10A) via a non-computer communication format. In one implementation, a business transaction document transmission service fee is charged to the transmitting party (e.g., party 10B) for each electronic business transaction document 54 that is transmitted from transaction service server 18.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. An electronic business transaction service method for conducting a business transaction over a computer network, comprising:
creating on a first computer an electronic business transaction document that is compatible with a business management software program, the electronic business transaction document being directed to plural recipient parties to a business transaction, the electronic business transaction document being directed to at least one recipient party in a computer communication format and to at least one other recipient party in a non-computer communication format;
transmitting the electronic business transaction document over the computer network to a network-connected transaction service server computer; and
sending the electronic business transaction document from the transaction service server computer to the recipient parties in the computer and non-computer communication formats.

2. The method of claim 1 in which the non-computer communication format includes telephonic facsimile.

3. The method of claim 1 further comprising transmitting a printed copy of the electronic business transaction document to a recipient party.

4. The method of claim 1 further storing in an electronic address book associated with the business management software program address information for each party and a communication format indication for each party indicating the one of the computer and non-computer communication formats in which to transmit communications to the party.

5. The method of claim 4 in which user selection of a party to receive an electronic business transaction document automatically associates with the party the communication format indicated in the communication format indication.

6. The method of claim 1 further comprising charging a fee for each recipient party to which the electronic business transaction document is sent from the transaction service server.

7. The method of claim 1 in which the business management software program is capable of automatically populating and extracting information from electronic business transaction document, the method further including transmitting a business management software component or access to it with the electronic business transaction document in the computer format to the at least one recipient party, if it is determined that the at least one recipient party is not capable of viewing the electronic business transaction document, the business management software component not being capable of automatically populating and extracting information from electronic business transaction documents.

8. The method of claim 1 in which the electronic business transaction document includes a markup language computer file.

9. The method of claim 8 in which the markup language computer file includes Extensible Markup Language.

10. The method of claim 1 in which the business transaction relates to a construction project.

11. In a computer readable medium, an electronic business transaction document data structure, comprising:
a business transaction document form identifier for identifying a business transaction document form corresponding to an electronic business transaction document;
a recipient identifier for identifying each of plural recipients to whom the electronic business transaction document is directed;
a communication format identifier for a communication format for each of the plural recipients.

12. The medium of claim 11 in which the communication format identifiers for the plural recipients include computer and non-computer communication formats.

13. The medium of claim 12 in which the non-computer communication formats include telephonic facsimile communication.

14. In computer readable media, electronic business transaction service software for conducting a business transaction over a computer network, comprising:
software for creating on a first computer an electronic business transaction document that is compatible with a business management software program, the electronic business transaction document being directed to plural recipient parties to a business transaction, the electronic business transaction document being directed to at least one recipient party in a computer communication format and to at least one other recipient party in a non-computer communication format;
software for transmitting the electronic business transaction document over the computer network to a network-connected transaction service server computer; and
software for sending the electronic business transaction document from the transaction service server computer to the recipient parties in the computer and non-computer communication formats.

15. The media of claim 14 further software for storing in an electronic address book associated with the business management software program address information for each party and a communication format indication for each party indicating the one of the computer and non-computer communication formats in which to transmit communications to the party.

16. The media of claim 15 in which user selection of a party to receive an electronic business transaction document automatically associates with the party the communication format indicated in the communication format indication.

17. The media of claim 14 further comprising software for charging a fee for each recipient party to which the electronic business transaction document is sent from the transaction service server.

18. The media of claim 14 in which the business transaction relates to a construction project.

19. An electronic business transaction service method for conducting a business transaction over a computer network, comprising:
creating on a first computer an electronic business transaction document that is compatible with a business management software program, the electronic business transaction document being directed in one or more communication formats to plural recipient parties to a business transaction;
transmitting the electronic business transaction document over the computer network to a network-connected transaction service server computer; and
sending the electronic business transaction document from the transaction service server computer to the recipient parties in the one or more communication formats.

20. The method of claim 19 in which one of the communication formats includes telephonic facsimile.

21. The method of claim 19 further storing in an electronic address book associated with the business management software program address information for each party and a communication format indication for each party indicating a default communication format in which to transmit communications to the party.

22. The method of claim 21 in which user selection of a party to receive an electronic business transaction document automatically associates with the party the default communication format indicated in the communication format indication.

23. The method of claim 22 further comprising manually changing from the default communication format automatically associated with the party prior to sending the electronic business transaction document from to a recipient party.

24. The method of claim 19 further comprising charging a fee for each recipient party to which the electronic business transaction document is sent from the transaction service server.
